(19) United States
(12) Patent Application Publication
(10) Pub. No.: US 2014/0240479 A1
(43) Pub. Date: Aug. 28, 2014

(54) INFORMATION PROCESSING APPARATUS FOR WATCHING, INFORMATION PROCESSING METHOD AND NON-TRANSITORY RECORDING MEDIUM RECORDED WITH PROGRAM

(71) Applicant: NK WORKS CO., LTD., Wakayama-shi (JP)

(72) Inventors: Toru Yasukawa, Wakayama-shi (JP); Masayoshi Uetsuji, Wakayama-shi (JP); Takeshi Murai, Wakayama-shi (JP); Shuichi Matsumoto, Wakayama-shi (JP); Shoichi Dedachi, Wakayama-shi (JP)

(73) Assignee: NK WORKS CO., LTD., Wakayama-shi (JP)

(21) Appl. No.: 14/190,677

(22) Filed: Feb. 26, 2014

(30) Foreign Application Priority Data
Feb. 28, 2013 (JP) 2013-038575

(51) Int. Cl. G06K 9/00; H04N 7/18

(52) U.S. Cl. CPC G06K 9/00342; H04N 7/183
USPC 348/77

(57) ABSTRACT

An information processing apparatus according to one aspect of the present invention is disclosed, which includes an image acquiring unit acquiring moving images captured as images of a watching target person and a target object as a reference for the behavior thereof, a moving object detecting unit detecting a moving-object area with a motion occurring from the moving images, and a behavior presuming unit presuming a behavior of the watching target person about the target object corresponding to a positional relationship between a target object area set within the moving images and the detected moving-object area.

### FIELD

The present invention relates to an information processing apparatus for watching, an information processing method and a non-transitory recording medium recorded with a program.

### BACKGROUND

A technology (Japanese Patent Application Laid-Open Publication No. 2002-230533) exists, which determines a get-into-bed event by detecting a movement of a human body from a floor area into a bed area in a way that passes through a frame border of an image captured from upward indoors to downward indoors, and determines a leaving-bed event by detecting a movement of the human body from the bed area down to the floor area.

Another technology (Japanese Patent Application Laid-Open Publication No. 2011-005171) exists, which sets a watching area for detecting that a patient lying down on the bed conducts a behavior of getting up from the bed as an area immediately above the bed, which covers the patient sleeping in the bed, and determines that the patient conducts a behavior of getting up from the bed if a variation value representing a size of an image area of a deemed-to-be patient that occupies a watching area of a captured image covering the watching area from a crosswise direction of the bed, is less than an initial value representing a size of the image area of the deemed-to-be patient that occupies the watching area of a captured image obtained from a camera in a state of the patient lying on the bed.

In recent years, there has been an annually increasing tendency of accidents that inpatients, care facility tenants, care receivers, etc fall down or come down from beds and of accidents caused by wandering of dementia patients. A watching system utilized in, e.g., a hospital, a care facility, etc is developed as a method of preventing those accidents. The watching system is configured to detect behaviors of a watching target person such as a get-up state, a sitting-on-bed-edge state and a leaving-bed state by capturing an image of the watching target person with a camera installed indoors and analyzing the captured image. This type of watching system involves using a comparatively high-level image processing technology such as a facial recognition technology for specifying the watching target person, however, a problem inherent in the system lies in a difficulty of utilizing the system to adjust system settings corresponding to medical or nursing care sites.

### SUMMARY

According to one aspect of the present invention, an information processing apparatus includes: an image acquiring unit to acquire moving images captured as an image of a watching target person whose behavior is watched and an image of a target object serving as a reference for the behavior of the watching target person; a moving object detecting unit to detect a moving-object area where a motion occurs from within the acquired moving images; and a behavior presuming unit to presume a behavior of the watching target person with respect to the target object in accordance with a positional relationship between a target object area set within the moving images as an area where the target object exists and the detected moving-object area.

According to the configuration described above, the moving-object area is detected, in which the motion occurs from within the moving images captured as the image of the watching target person whose behavior is watched and the image of the target object serving as the reference for the behavior of the watching target person. In other words, the area covering an existence of a moving object is detected. Then, the behavior of the watching target person with respect to the target object is presumed in accordance with the positional relationship between the target object area set within the moving images as the area covering the existence of the target object that serves as the reference for the behavior of the watching target person and the detected moving-object area. Note that the watching target person connotes a target person whose behavior is watched by the information processing apparatus and is exemplified by an inpatient, a care facility tenant and a care receiver.

Hence, according to the configuration, the behavior of the watching target person is presumed from the positional relationship between the target object and the moving object, and it is therefore feasible to presume the behavior of the watching target person by a simple method without introducing a high-level image processing technology such as image recognition.

Further, by way of another mode of the information processing apparatus according to one aspect, the behavior presuming unit may presume the behavior of the watching target person with respect to the target object further in accordance with a size of the detected moving-object area. The configuration described above enables elimination of the moving object unrelated to the behavior of the watching target person and consequently enables accuracy of presuming the behavior to be enhanced.

Moreover, by way of still another mode of the information processing apparatus according to one aspect, the moving object detecting unit may detect the moving-object area from within a detection area set as area for presuming the behavior of the watching target person in the acquired moving images. The configuration described above enables a reduction of a target range for detecting the moving object in the moving images and therefore enables a process related to the detection thereof to be executed at a high speed.

Furthermore, by way of yet another mode of the information processing apparatus according to one aspect, the moving object detecting unit may detect the moving-object area from within the detection area determined based on types of the behaviors of the watching target person that are to be presumed. The configuration described above enables ignorance of the moving object occurring in an area unrelated to the presumption target behavior and consequently enables the accuracy of presuming the behavior to be enhanced.

Moreover, by way of a further mode of the information processing apparatus according to one aspect, the image acquiring unit may acquire the moving image captured as an image of a bed defined as the target object, and the behavior presuming unit may presume at least any one of the behaviors of the watching target person such as a get-up state on the bed, a sitting-on-bed-edge state, an over-bed-fence state, a come-down state from the bed and a leaving-bed state. Note that the sitting-on-bed-edge state indicates a state where the watching target person sits on an edge of the bed. According to the configuration described above, it is feasible to presume at least any one of the behaviors of the watching target person such as the get-up state on the bed, the sitting-on-bed-edge state, the over-bed-fence state, the come-down state and the leaving-bed state. Therefore, the information processing apparatus can be utilized as an apparatus for watching the inpatient, the care facility tenant, the care receiver, etc in the hospital, the care facility and so on.

Moreover, by way of a still further mode of the information processing apparatus according to one aspect, the information processing apparatus may further include a notifying unit to notify, when the presumed behavior of the watching target person is a behavior indicating the symptom that the watching target person will encounter with an impending danger, a watcher to watch the watching target person of this symptom. According to the configuration described above, the watcher can be notified of the symptom that the watching target person will encounter with the impending danger. Further, the watching target person can be also notified of the symptom of the impending danger. Note that the watcher is the person who watches the behavior of the watching target person and is exemplified by a nurse, care facility staff and a caregiver if the watching target persons are the inpatient, the care facility tenant, the care receiver, etc. Moreover, the notification for informing of the symptom that the watching target person will encounter with the impending danger may be issued in cooperation with equipment installed in a facility such as a nurse call system.

It is to be noted that another mode of the information processing apparatus according to one aspect may be an information processing system realizing the respective configurations described above, may also be an information processing method, may further be a program, and may yet further be a non-transitory storage medium recording a program, which can be read by a computer, other apparatuses and machines. Herein, the recording medium readable by the computer etc is a medium that accumulates the information such as the program electrically, magnetically, mechanically or by chemical action. Moreover, the information processing system may be realized by one or a plurality of information processing systems.

For example, according to one aspect of the present invention, an information processing method is a method by which a computer executes: acquiring moving images captured as an image of a watching target person whose behavior is watched and an image of a target object serving as a reference for the behavior of the watching target person; detecting a moving-object area where a motion occurs from within the acquired moving images; and presuming a behavior of the watching target person with respect to the target object in accordance with a positional relationship between a target object area set within the moving images as an area where the target object exists and the detected moving-object area.

Furthermore, according to one aspect of the present invention, a non-transitory recording medium records a program to make a computer execute: acquiring moving images captured as an image of a watching target person whose behavior is watched and an image of a target object serving as a reference for the behavior of the watching target person; detecting a moving-object area where a motion occurs from within the acquired moving images; and presuming a behavior of the watching target person with respect to the target object in accordance with a positional relationship between a target object area set within the moving images as an area where the target object exists and the detected moving-object area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates one example of a situation to which the present invention is applied;

FIG. 2 is a view illustrating a hardware configuration of an information processing apparatus according to an embodiment;

FIG. 3 is a view illustrating a functional configuration of the information processing apparatus according to the embodiment;

FIG. 4 is a flowchart illustrating a processing procedure of the information processing apparatus according to the embodiment;

FIG. 5A is a view illustrating a situation in which a watching target person is in a get-up state; FIG. 5B is a view illustrating one example of a moving image acquired when the watching target person becomes the get-up state; and FIG. 5C is a view illustrating a relationship between a moving object detected from within the moving images acquired when the watching target person becomes the get-up state and a target object;

FIG. 6A is a view illustrating a situation in which the watching target person is in a sitting-on-bed-edge state; FIG. 6B is a view illustrating one example of a moving image acquired when the watching target person becomes the sitting-on-bed-edge state; and FIG. 6C is a view illustrating a relationship between the moving object detected from within the moving images acquired when the watching target person becomes the sitting-on-bed-edge state and the target object;

FIG. 7A is a view illustrating a situation in which the watching target person is in an over-bed-fence state; FIG. 7B is a view illustrating one example of a moving image acquired when the watching target person becomes the over-bed-fence state; and FIG. 7C is a view illustrating a relationship between the moving object detected from within the moving images acquired when the watching target person becomes the over-bed-fence state and the target object;

FIG. 8A is a view illustrating a situation in which the watching target person is in a come-down state from the bed; FIG. 8B is a view illustrating one example of a moving image acquired when the watching target person becomes the come-down state from the bed; and FIG. 8C is a view illustrating a relationship between the moving object detected from within the moving images acquired when the watching target person becomes the come-down state from the bed and the target object;

FIG. 9A is a view illustrating a situation in which the watching target person is in a leaving-bed state; FIG. 9B is a view illustrating one example of a moving image acquired when the watching target person becomes the leaving-bed state; and FIG. 9C is a view illustrating a relationship between the moving object detected from within the moving images acquired when the watching target person becomes the leaving-bed state and the target object; and

FIG. 10A is a view illustrating one example of a detection area set as an area for detecting the moving object; and FIG. 10B is a view illustrating one example of the detection area set as the area for detecting the moving object.

### DESCRIPTION OF EMBODIMENT

An embodiment (which will hereinafter be also termed “the present embodiment”) according to one aspect of the present invention will hereinafter be described based on the drawings. However, the present embodiment, which will hereinafter be explained, is no more than an exemplification of the present invention in every point. As a matter of course, the invention can be improved and modified in a variety of forms without deviating from the scope of the present invention. Namely, on the occasion of carrying out the present invention, a specific configuration corresponding to the embodiment may properly be adopted.

Note that data occurring in the present embodiment are, though described in a natural language, specified more concretely by use of a quasi-language, commands, parameters, a machine language, etc, which are recognizable to a computer.

### §1 Example of Applied Situation

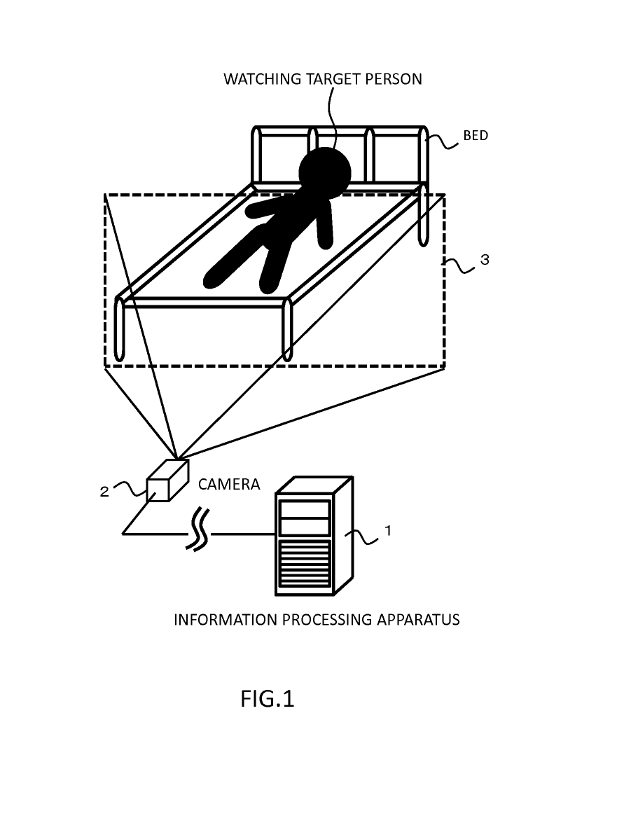

FIG. 1 illustrates one example of a situation to which the present invention is applied. The present embodiment assumes a situation of watching a behavior of an inpatient in a medical treatment facility or a tenant in a nursing facility as a watching target person. An image of the watching target person is captured by a camera 2 installed at a front of a bed in a longitudinal direction, thus watching a behavior thereof.

The camera 2 captures an image of a watching target person whose behavior is watched and an image of a target object serving as a reference for the behavior of the watching target person. The target object serving as the reference for the behavior of the watching target person may be properly selected corresponding to the embodiment. In the present embodiment, the behavior of the inpatient in a hospital room or the behavior of the tenant in the nursing facility is watched, and hence a bed is selected as the target object serving as the reference for the behavior of the watching target person.

Note that a type of the camera 2 and a disposing position thereof may be properly selected corresponding to the embodiment. In the present embodiment, the camera 2 is fixed to get capable of capturing the image of the watching target person and the image of the bed from a front side of the bed in the longitudinal direction. Moving images 3 captured by the camera 2 are transmitted to an information processing apparatus 1.

The information processing apparatus 1 according to the present embodiment acquires the moving images 3 captured as the images of the watching target person and the target object (bed) from the camera 2. Then, the information processing apparatus 1 detects a moving-object area with a motion occurring, in other words, an area where a moving object exists from within the acquired moving images 3, and presumes the behavior of the watching target person with respect to the target object (bed) in accordance with a relationship between a target object area set within the moving images 3 as the area where the target object (bed) exists and the detected moving-object area.

Note that the behavior of the watching target person with respect to the target object is defined as a behavior of the watching target person in relation to the target object in the behaviors of the watching target person, and may be properly selected corresponding to the embodiment. In the present embodiment, the bed is selected as the target object serving as the reference for the behavior of the watching target person. This being the case, the information processing apparatus 1 according to the present embodiment presumes, as the behavior of the watching target person with respect to the bed, at least any one of behaviors such as a get-up state on the bed, a sitting-on-bed-edge state, an over-bed-fence state, a come-down state from the bed and a leaving-bed state. With this contrivance, the information processing apparatus 1 can be utilized as an apparatus for watching the inpatient, the facility tenant, the care receiver, etc in the hospital, the nursing facility and so on. An in-depth description thereof will be given later on.

Thus, according to the present embodiment, the moving object is detected from within the moving images 3 captured as the image of the watching target person and the image of the target object serving as the reference for the behavior of the watching target person. Then, the behavior of the watching target person with respect to the target object is presumed based on a positional relationship between the target object and the detected moving object.

Hence, according to the present embodiment, there behavior of the watching target person can be presumed from the positional relationship between the target object and the moving object, and it is therefore feasible to presume the behavior of the watching target person by a simple method without introducing a high-level image processing technology such as image recognition (computer vision).

### §2 Example of Configuration

<Example of Hardware Configuration>

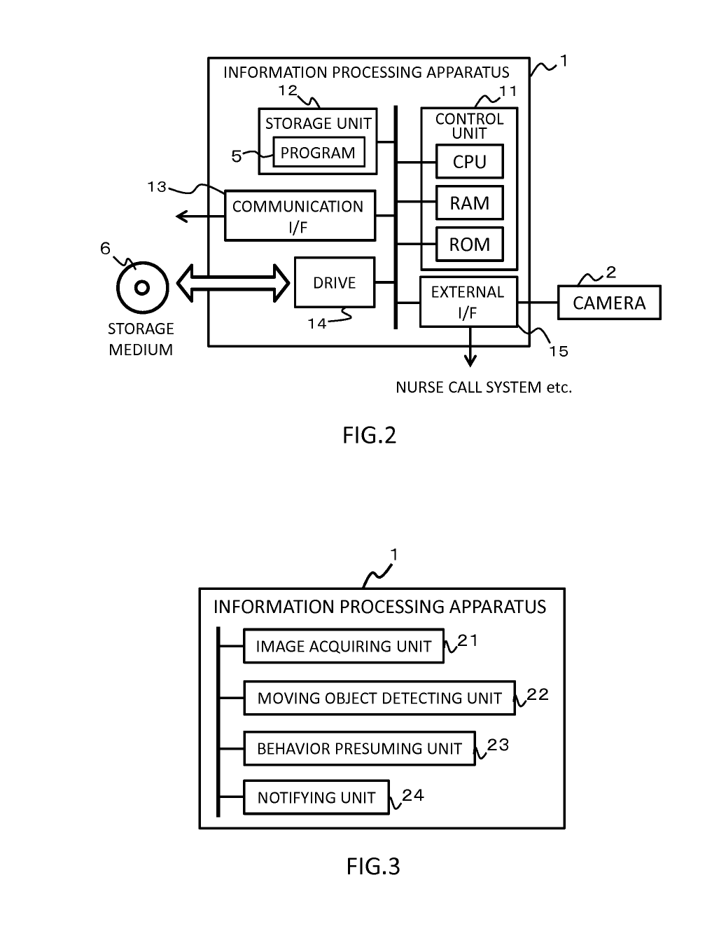

FIG. 2 illustrates a hardware configuration of the information processing apparatus 1 according to the present embodiment. The information processing apparatus 1 is a computer including: a control unit 11 containing a CPU, a RAM (Random Access Memory) and a ROM (Read Only Memory); a storage unit 12 storing a program 5 etc executed by the control unit 11; a communication interface 13 for performing communications via a network; a drive 14 for reading a program stored on a storage medium 6; and an external interface 15 for establishing a connection with an external device, which are all electrically connected to each other.

Note that as for the specific hardware configuration of the information processing apparatus 1, the components thereof can be properly omitted, replaced and added corresponding to the embodiment. For instance, the control unit 11 may include a plurality of processors. Furthermore, the information processing apparatus 1 may be equipped with output devices such as a display and input devices for inputting such as a mouse and a keyboard. Note that the communication interface and the external interface are abbreviated to the “communication I/F” and the “external I/F” respectively in FIG. 2.

Moreover, the information processing apparatus 1 may include a plurality of external interfaces 15 and may be connected to external devices through these interfaces 15. In the present embodiment, the information processing apparatus 1 may be connected to the camera 2, which captures the image of the watching target person and the image of the bed, via the external I/F 15. Further, the information processing apparatus 1 is connected via the external I/F 15 to equipment installed in a facility such as a nurse call system, whereby notification for informing of a symptom that the watching target person will encounter with an impending danger may be issued in cooperation with the equipment.

Moreover, the program 5 is a program for making the information processing apparatus 1 execute steps contained in the operation that will be explained later on, and corresponds to a “program” according to the present invention. Moreover, the program 5 may be recorded on the storage medium 6. The storage medium 6 is a non-transitory medium that accumulates information such as the program electrically, magnetically, optically, mechanically or by chemical action so that the computer, other apparatus and machines, etc can read the information such as the recorded program. The storage medium 6 corresponds to a “non-transitory storage medium” according to the present invention. Note that FIG. 2 illustrates a disk type storage medium such as a CD (Compact Disk) and a DVD (Digital Versatile Disk) byway of one example of the storage medium 6. It does not, however, mean that the type of the storage medium 6 is limited to the disk type, and other types excluding the disk type may be available. The storage medium other than the disk type can be exemplified by a semiconductor memory such as a flash memory.

Further, the information processing apparatus 1 may involve using, in addition to, e.g., an apparatus designed for an exclusive use for a service to be provided, general-purpose apparatuses such as a PC (Personal Computer) and a tablet terminal. Further, the information processing apparatus 1 may be implemented by one or a plurality of computers.

<Example of Functional Configuration>

FIG. 3 illustrates a functional configuration of the information processing apparatus 1 according to the present embodiment. The CPU provided in the information processing apparatus 1 according to the present embodiment deploys the program 5 on the RAM, which is stored in the storage unit 12. Then, the CPU interprets and executes the program 5 deployed on the RAM, thereby controlling the respective components. Through this operation, the information processing apparatus 1 according to the present embodiment functions as the computer including an image acquiring unit 21, a moving object detecting unit 22, a behavior presuming unit 23 and a notifying unit 24.

The image acquiring unit 21 acquires the moving images 3 captured as the image of the watching target person whose behavior is watched and as the image of the target object serving as the reference for the behavior of the watching target person. The moving object detecting unit 22 detects the moving-object area with the motion occurring from within the acquired moving images 3. Then, the behavior presuming unit 23 presumes the behavior of the watching target person with respect to the target object on the basis of the positional relationship between the target object area set within the moving images 3 as an area where the target object exists and the detected moving-object area.

Note that the behavior presuming unit 23 may presume the behavior of the watching target person with respect to the target object further on the basis of a size of the detected moving-object area. The present embodiment does not involve recognizing the moving object existing in the moving-object area. Therefore, the information processing apparatus 1 according to the present embodiment has a possibility to presume the behavior of the watching target person on the basis of the moving object unrelated to the motion of the watching target person. Such being the case, the behavior presuming unit 23 may presume the behavior of the watching target person with respect to the target object further on the basis of the size of the detected moving-object area. Namely, the behavior presuming unit 23 may enhance accuracy of presuming the behavior by excluding the moving-object area unrelated to the motion of the watching target person on the basis of the size of the moving-object area.

In this case, the behavior presuming unit 23 excludes the moving-object area that is apparently smaller in size than the watching target person, and may presume that the moving-object area larger than a predetermined size being changeable in setting by a user (e.g. a watcher) is related to the motion of the watching target person. Namely, the behavior presuming unit 23 may presume the behavior of the watching target person by use of the moving-object area larger that the predetermined size. This contrivance enables the moving object unrelated to the motion of the watching target person to be excluded from behavior presuming targets and the behavior presuming accuracy to be enhanced.

The process described above does not, however, hinder the information processing apparatus 1 from recognizing the moving object existing in the moving-object area. The information processing apparatus 1 according to the present embodiment determines, by recognizing the moving object existing in the moving-object area, whether or not the moving object projected in the moving-object area is related to the watching target person or not, and may exclude the moving object unrelated to the watching target person from the behavior presuming process.

Further, the moving object detecting unit 22 may detect the moving-object area in a detection area set as an area for presuming the behavior of the watching target person in the moving images 3 to be acquired. Supposing that a range in which to detect the moving object is not limited in the moving images 3, the watching target person does not necessarily move over an entire area covering the moving images 3, and hence such a possibility exists that a moving object unrelated to the motion of the watching target person is detected. This being the case, the moving object detecting unit 22 may detect the moving-object area in the detection area set as the area for presuming the behavior of the watching target person in the moving images 3 to be acquired. Namely, the moving object detecting unit 22 may confine a target range in which to detect the moving object to the detection area.

The setting of this detection area can reduce the possibility of detecting the moving object unrelated to the motion of the watching target person because of there being a possibility of excluding the area unrelated to the motion of the watching target person from the moving object detection target. Moreover, a processing range for detecting the moving object is limited, and therefore the process related to the detection of the moving object can be executed faster than in the case of processing the whole moving images 3.

Further, the moving object detecting unit 22 may also detect the moving-object area from the detection area determined based on types of the behaviors of the watching target person, which are to be presumed. Namely, the detection area set as the area in which to detect the moving object may be determined based on the types of the watching target person's behaviors to be presumed. This scheme, in the information processing apparatus 1 according to the present embodiment, enables ignorance of the moving object occurring in the area unrelated to the behaviors set as the presumption targets, whereby the accuracy for presuming the behavior can be enhanced.

Furthermore, the information processing apparatus 1 according to the present embodiment includes the notifying unit 24 for issuing, when the presumed behavior of the watching target person is the behavior indicating the symptom that the watching target person will encounter with the impending danger, the notification for informing the symptom to the watcher who watches the watching target person. With this configuration, in the information processing apparatus 1 according to the embodiment of the present application, the watcher can be informed of the symptom that the watching target person will encounter with the impending danger. Further, the watching target person himself or herself can be also informed of the symptom of the impending danger. Note that the watcher is the person who watches the behavior of the watching target person and is exemplified by a nurse, staff and a caregiver if the watching target persons are the inpatient, the care facility tenant, the care receiver, etc. Moreover, the notification for informing of the symptom that the watching target person will encounter with the impending danger may be issued in cooperation with equipment installed in a facility such as a nurse call system.

It is to be noted that in the present embodiment, the image acquiring unit 21 acquires the moving images 3 containing the captured image of the bed as the target object becoming the reference for the behavior of the watching target person. Then, the behavior presuming unit 23 presumes at least any one of the behaviors of the watching target person such as the get-up state on the bed, the sitting-on-bed-edge state, the over-bed-fence state, the come-down state from the bed and the leaving-bed state. For this purpose, the information processing apparatus 1 according to the present embodiment can be utilized as an apparatus for watching the inpatient, the care facility tenant, the care receiver, etc in the care facility and so on.

Note that the present embodiment discusses the example in which each of these functions is realized by the general-purpose CPU. Some or the whole of these functions may, however, be realized by one or a plurality of dedicated processors. For example, in the case of not issuing the notification for informing of the symptom that the watching target person will encounter with the impending danger, the notifying unit 24 may be omitted.

### §3 Operational Example

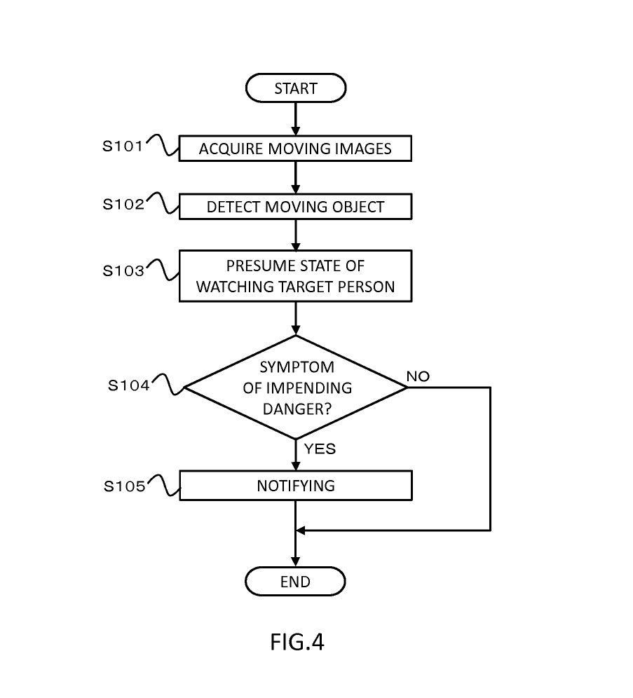

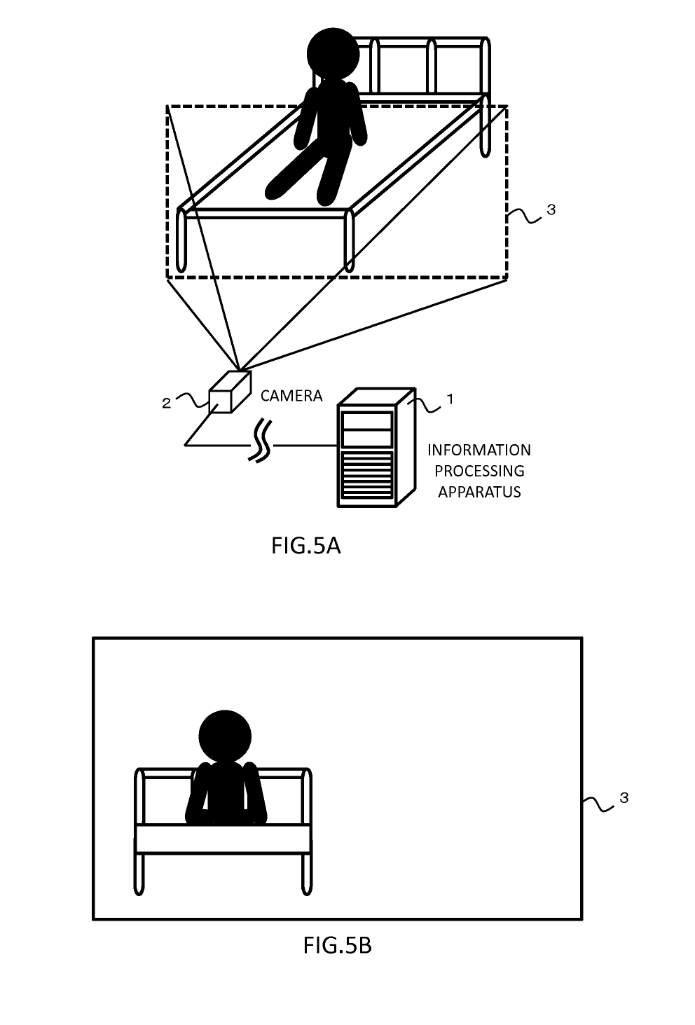

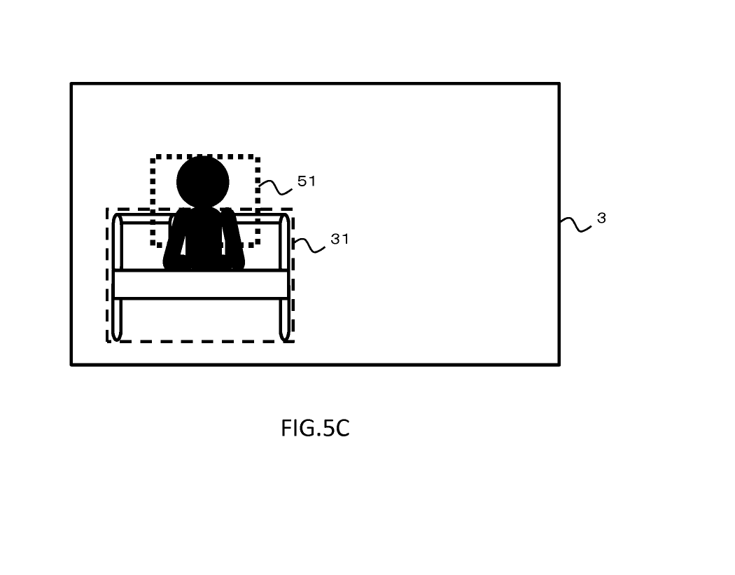

FIG. 4 illustrates an operational example of the information processing apparatus 1 according to the present embodiment. It is to be noted that a processing procedure of the operational example given in the following discussion is nothing but one example, and the respective processes may be replaced to the greatest possible degree. Further, as for the processing procedure of the operational example given in the following discussion, the processes thereof can be properly omitted, replaced and added corresponding to the embodiment. For instance, in the case of not issuing the notification for informing of the symptom that the watching target person will encounter with the impending danger, steps S104 and S105 may be omitted.

In step S101, the control unit 11 functions as the image acquiring unit 21 and acquires the moving images 3 captured as the image of the watching target person whose behavior is watched and the image of the target object serving as the reference for the behavior of the watching target person. In the present embodiment, the control unit 11 acquires, from the camera 2, the moving images 3 captured as the image of the inpatient or the care facility tenant and the image of the bed.

Herein, in the present embodiment, the information processing apparatus 1 is utilized for watching the inpatient or the care facility tenant in the medical treatment facility or the care facility. In this case, the control unit 11 may obtain the image in a way that synchronizes with the video signals of the camera 2. Then, the control unit 11 may promptly execute the processes in step S102 through step S105, which will be described later on, with respect to the acquired image. The information processing apparatus 1 consecutively execute this operation without interruption, thereby realizing real-time image processing and enabling the behaviors of the inpatient or the care facility tenant to be watched in real time.

In step S102, the control unit 11 functions as the moving object detecting unit 22 and detects the moving-object area in which the motion occurs, in other words, the area where the moving object exists from within the moving images acquired in step S101. A method of detecting the moving object can be exemplified by a method using a differential image and a method employing an optical flow.

The method using the differential image is a method of detecting the moving object by observing a difference between plural frames of images captured at different points of time. Concrete examples of this method can be given such as a background difference method of detecting the moving-object area from a difference between a background image and an input image, an inter-frame difference method of detecting the moving-object area by using three frames of images different from each other, and a statistic background difference method of detecting the moving image by applying a statistic model.

Further, the method using the optical flow is a method of detecting the moving object on the basis of the optical flow in which a motion of the object is expressed by vectors. Specifically, the optical flow is a method of expressing, as vector data, moving quantities (flow vectors) of the same object, which are associated between two frames of the images captured at different points of time. Methods, which can be given by way of examples of the method of obtaining the optical flow, are a block matching method of obtaining the optical flow by use of, e.g., template matching and a gradient-based approach for obtaining the optical flow by utilizing a constraint of space-time derivation. The optical flow expresses the moving quantities of the object, and therefore the present method is capable of detecting the moving-object area by aggregating pixels that are not zero in vector value of the optical flow.

The control unit 11 may detect the moving object by selecting any one of these methods. Moreover, the moving object detecting method may also be selected by the user from within the methods described above. The moving object detecting method is not limited to any particular method but may be properly selected.

In step S103, the control unit 11 functions as the behavior presuming unit 23 and presumes the behavior of the watching target person with respect to the target object in accordance with a positional relationship between a target object area set in the moving images 3 as a target object existing area and the moving-object area detected in step S102. In the present embodiment, the control unit 11 presumes at least any one of the behaviors of the watching target person with respect to the target object such as the get-up state on the bed, the sitting-on-bed-edge state, the over-bed-fence state, the come-down state from the bed and the leaving-bed state. The presumption of each behavior will hereinafter be described with reference to the drawings by giving a specific example. Note that the bed is selected as the target object serving as the reference for the behavior of the watching target person in the present embodiment, and hence the target object area may be referred to as a bed region, a bed area, etc.

(a) Get-Up State

FIGS. 5A-5C are views each related to a motion in the get-up state. FIG. 5A illustrates a situation where the watching target person in the get-up state. FIG. 5B depicts one situation in the moving image 3 captured by the camera 2 when the watching target person becomes the get-up state. FIG. 5C illustrates a positional relationship between the moving object to be detected and the target object (bed) in the moving images 3 acquired when the watching target person becomes the get-up state.

It is assumed that the watching target person gets up as illustrated in FIG. 5A from a state as depicted in FIG. 1, in other words, a state of sleeping with the body lying in his or her back (a face-up position) on the bed. In this case, the control unit 11 of the information processing apparatus 1 can acquire in step S101 the moving images 3 as one situation is illustrated in FIG. 5B from the camera 2 capturing the image of the watching target person and the image of the bed from the front side of the bed in the longitudinal direction.

At this time, the watching target person raises an upper half of the body from the state in the face-up position, and it is therefore assumed that a motion will occur in the area above the bed, i.e., the area in which to project the upper half of the body of the watching target person in the moving images 3 acquired in step S101. Namely, it is assumed that a moving-object area 51 is detected in the vicinity of the position illustrated in FIG. 5C in step S102.

Herein, as depicted in FIG. 5C, an assumption is that a target object area 31 is set to cover a bed projected area (including a bed frame) within the moving images 3. In that case, when the watching target person gets up from the bed, it is assumed that the moving-object area 51 is detected in the periphery of an upper edge of the target object area 31 in step S102.

Such being the case, in step S103, the control unit 11, when the moving-object area 51 is detected in the positional relationship with the target object area 31 as illustrated in FIG. 5C, in other words, when the moving-object area 51 is detected in the periphery of the upper edge of the target object area 31, presumes that the watching target person gets up from the bed. Note that the target object area 31 may be properly set corresponding to the embodiment. For instance, the target object area 31 may be set by the user in a manner that specifies the range and may also be set based on a predetermined pattern.

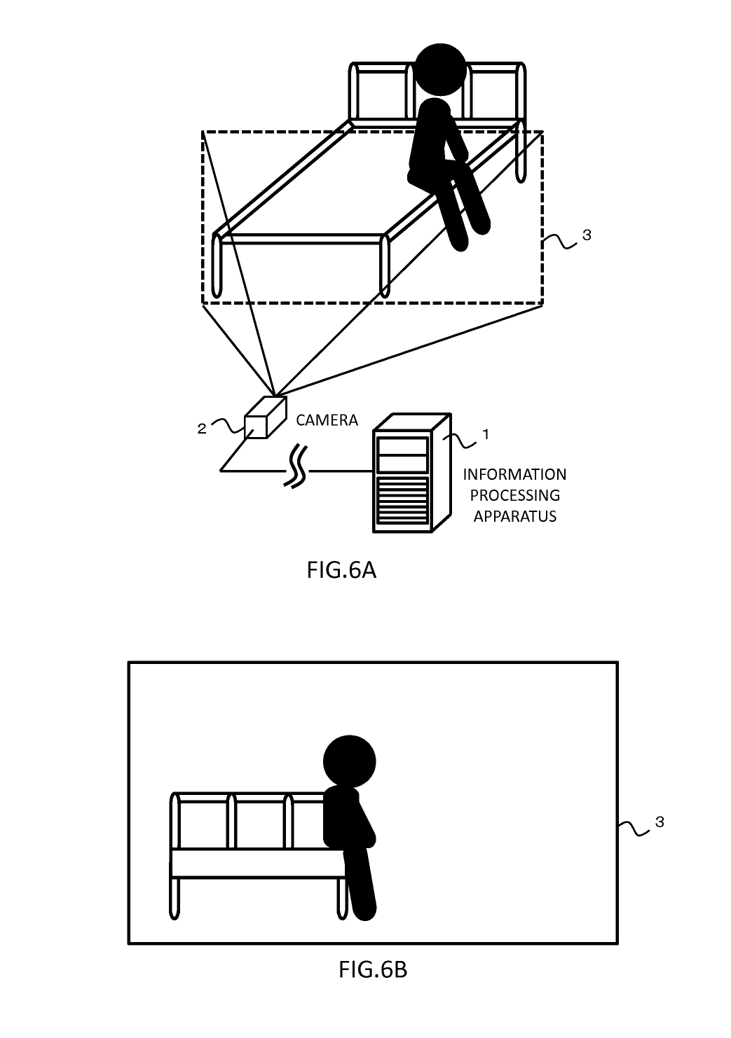

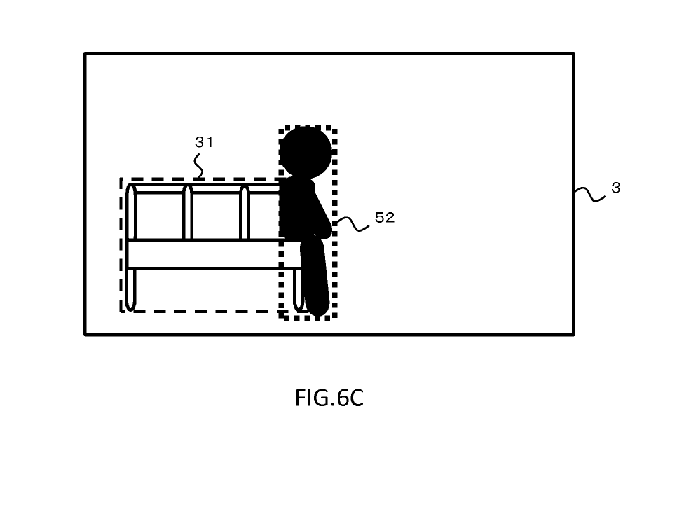

Incidentally, in FIG. 5C, the moving-object area (moving-object area 51) with the occurrence of the motion is illustrated as a rectangular area in shape. The illustration does not, however, imply that the moving-object area is to be detected as the rectangular area in shape. The same is applied to FIGS. 6C, 7C, 8C, 9C, 10A and 10B that will be illustrated later on.

(b) Sitting-on-Bed-Edge State

FIGS. 6A-6C are views each related to a motion in the sitting-on-bed-edge state. FIG. 6A illustrates a situation where the watching target person is in the sitting-on-bed-edge state. FIG. 6B depicts one situation in the moving image 3 captured by the camera 2 when the watching target person becomes the sitting-on-bed-edge state. FIG. 6C illustrates a positional relationship between the moving object to be detected and the target object (bed) in the moving images 3 acquired when the watching target person becomes the sitting-on-bed-edge state. Note that the sitting-on-bed-edge state indicates a state where the watching target person sits on the edge of the bed. Herein, in the present embodiment, the camera 2 is disposed so that the bed is projected in the area on the left side within the moving images 3. Accordingly, FIGS. 6A-6C each depict the situation where the watching target person is set on the right-sided edge of the bed as viewed from the camera 2.

When the watching target person becomes the sitting-on-bed-edge state as illustrated in FIG. 6A, the control unit 11 of the information processing apparatus 1 can acquire in step S101 the moving images 3 covering one situation as illustrated in FIG. 6B. At this time, the watching target person moves to sit on the right edge of the bed as viewed from the camera 2, and it is therefore assumed that the motion occurs over substantially the entire area of the edge of the bed in the moving images 3 acquired in step S101. To be specific, a moving-object area 52 is assumed to be detected in step S102 in the vicinity of the position depicted in FIG. 6C, in other words, in the vicinity of the right edge in the target object area 31.

This being the case, in step S103, the control unit 11, when the moving-object area 52 is detected in the positional relationship with the target object area 31 as illustrated in FIG. 6C, in other words, when the moving-object area 52 is detected in the vicinity of the right edge of the target object area 31, presumes that the watching target person becomes the sitting-on-bed-edge state.

(c) Over-Bed-Fence State

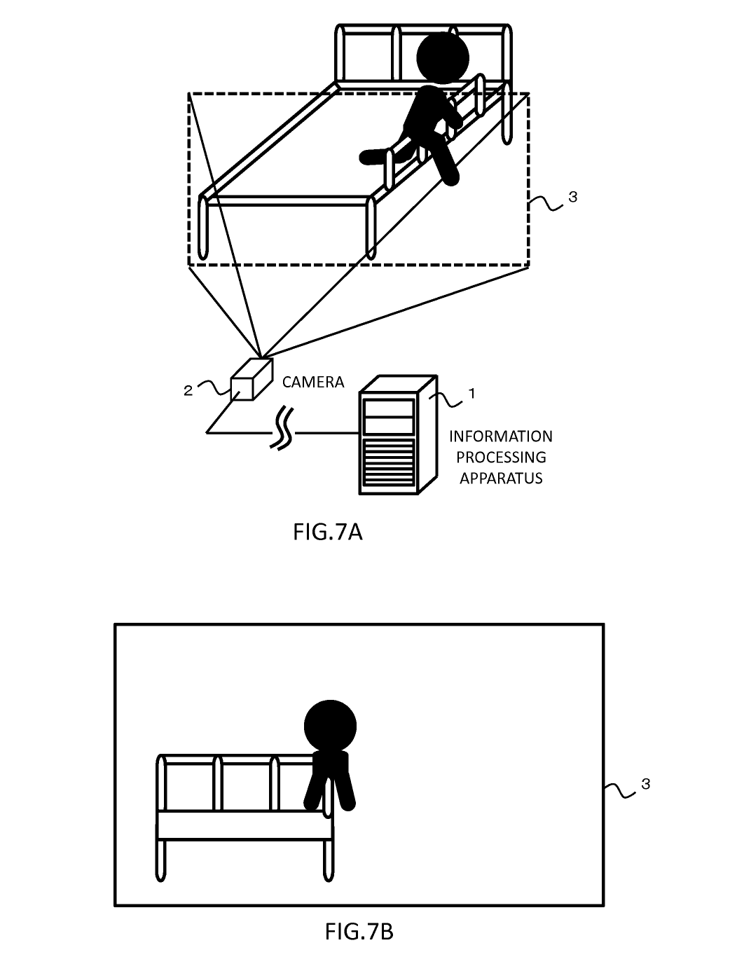

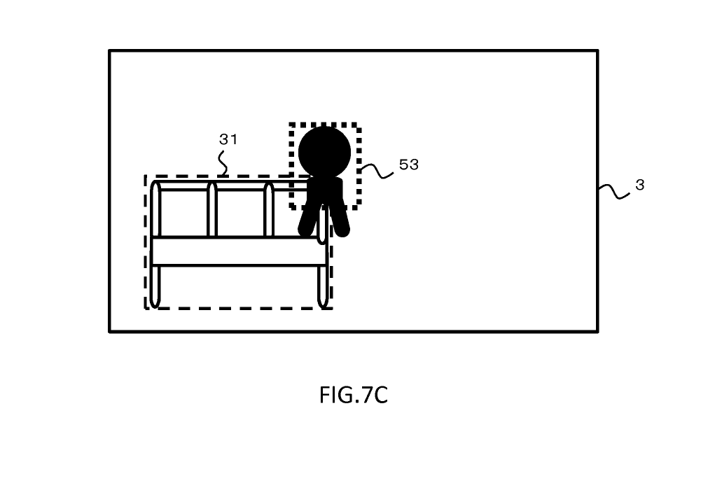

FIGS. 7A-7C are views each related to a motion in the over-bed-fence state. FIG. 7A illustrates a situation where the watching target person moves over the fence of the bed. FIG. 7B depicts one situation in the moving image 3 captured by the camera 2 when the watching target person moves over the fence of the bed. FIG. 7C illustrates a positional relationship between the moving object to be detected and the target object (bed) in the moving images 3 acquired when the watching target person moves over the fence of the bed. Herein, the camera 2 is disposed so that the bed is projected in the area on the left side within the moving images 3. Accordingly, similarly to the situation of the sitting-on-bed-edge state, FIGS. 7A-7C each depict the motion on the right-sided edge of the bed as viewed from the camera 2. Namely, FIGS. 7A-7C each illustrate a situation in which the watching target person just moves over the bed fence provided at the right edge as viewed from the camera 2.

When the watching target person moves over the fence of the bed as illustrated in FIG. 7A, the control unit 11 of the information processing apparatus 1 can acquire in step S101 the moving images 3 covering one situation as illustrated in FIG. 7B. At this time, the watching target person moves to get over the bed fence provided at the right edge as viewed from the camera 2, and hence it is assumed that the motion occurs at an upper portion of the right edge of the bed excluding the lower portion of the right edge of the bed in the moving images 3 acquired in step S101. To be specific, a moving-object area 53 is assumed to be detected in step S102 in the vicinity of the position illustrated in FIG. 7C, in other words, in the vicinity of the upper portion of the right edge of the target object area 31.

This being the case, in step S103, the control unit 11, when the moving-object area 53 is detected in the positional relationship with the target object area 31 as illustrated in FIG. 7C, in other words, when the moving-object area 53 is detected in the vicinity of the upper portion of the right edge of the target object area 31, presumes that the watching target person just moves over the fence of the bed.

(d) Come-Down State

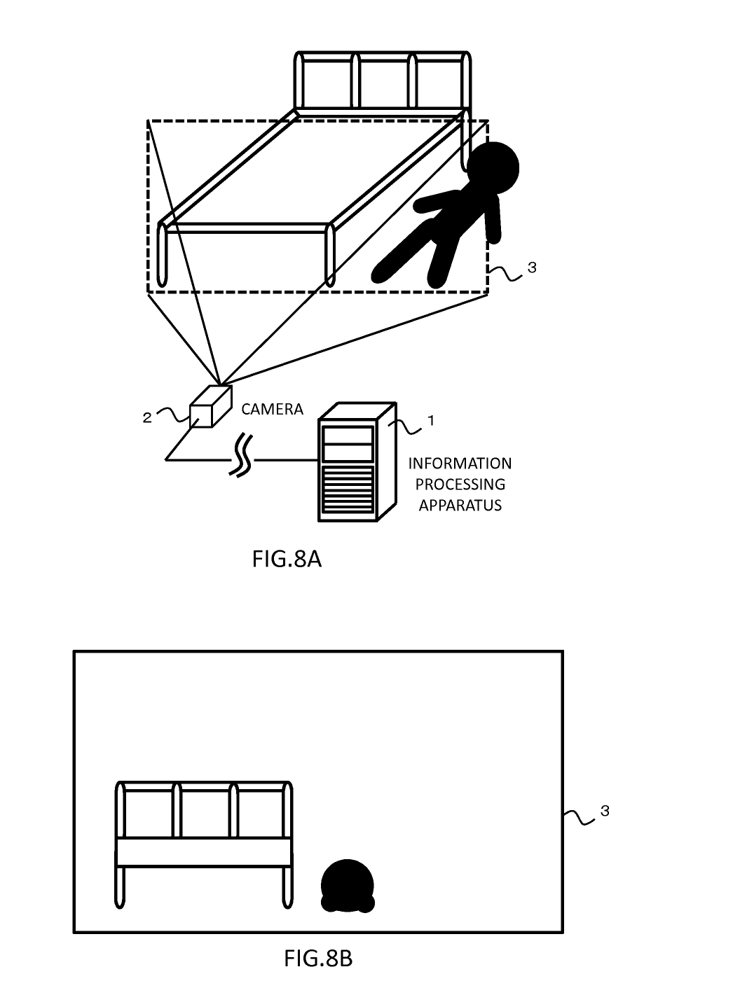

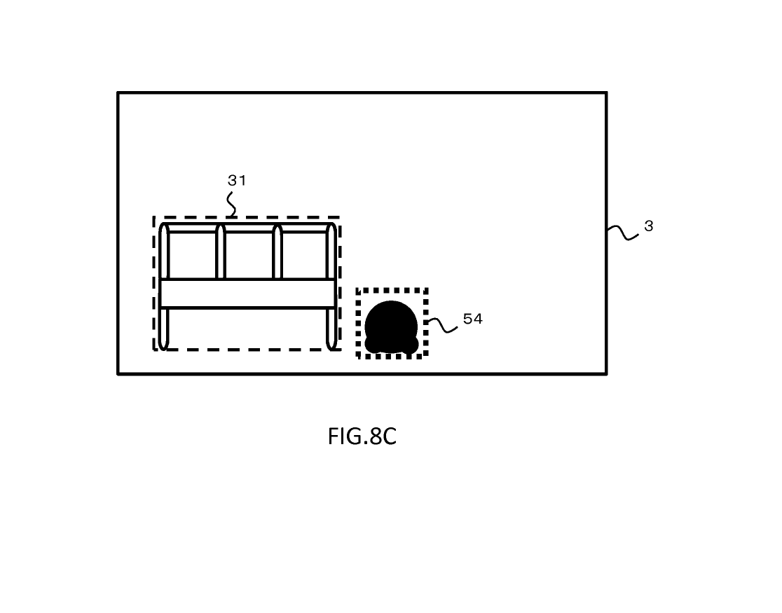

FIGS. 8A-8C are views each related to a motion in the come-down state from the bed. FIG. 8A illustrates a situation where the watching target person comes down from the bed. FIG. 8B depicts one situation in the moving image 3 captured by the camera 2 when the watching target person comes down from the bed. FIG. 8C illustrates a positional relationship between the moving object to be detected and the target object (bed) in the moving images 3 acquired when the watching target person comes down from the bed. Herein, for the same reason as the situations in the sitting-on-bed-edge state and in the over-bed-fence state, FIGS. 8A-8C each illustrate a situation in which the watching target person comes down from the bed on the right side as viewed from the camera 2.

When the watching target person comes down from the bed as illustrated in FIG. 8A, the control unit 11 of the information processing apparatus 1 can acquire in step S101 the moving images 3 covering one situation as illustrated in FIG. 8B. At this time, the watching target person comes down to beneath the bed from the right edge as viewed from the camera 2, and hence it is assumed that the motion occurs in the vicinity of a floor slightly distanced from the right edge of the bed in the moving images 3 acquired in step S101. To be specific, a moving-object area 54 is assumed to be detected in step S102 in the vicinity of the position illustrated in FIG. 8C, in other words, in the position slightly distanced rightward and downward from the target object area 31.

This being the case, in step S103, the control unit 11, when the moving-object area 54 is detected in the positional relationship with the target object area 31 as illustrated in FIG. 8C, in other words, when the moving-object area 54 is detected in the position slightly distanced rightward and downward from the target object area 31, presumes that the watching target person comes down from the bed.

(e) Leaving-Bed State

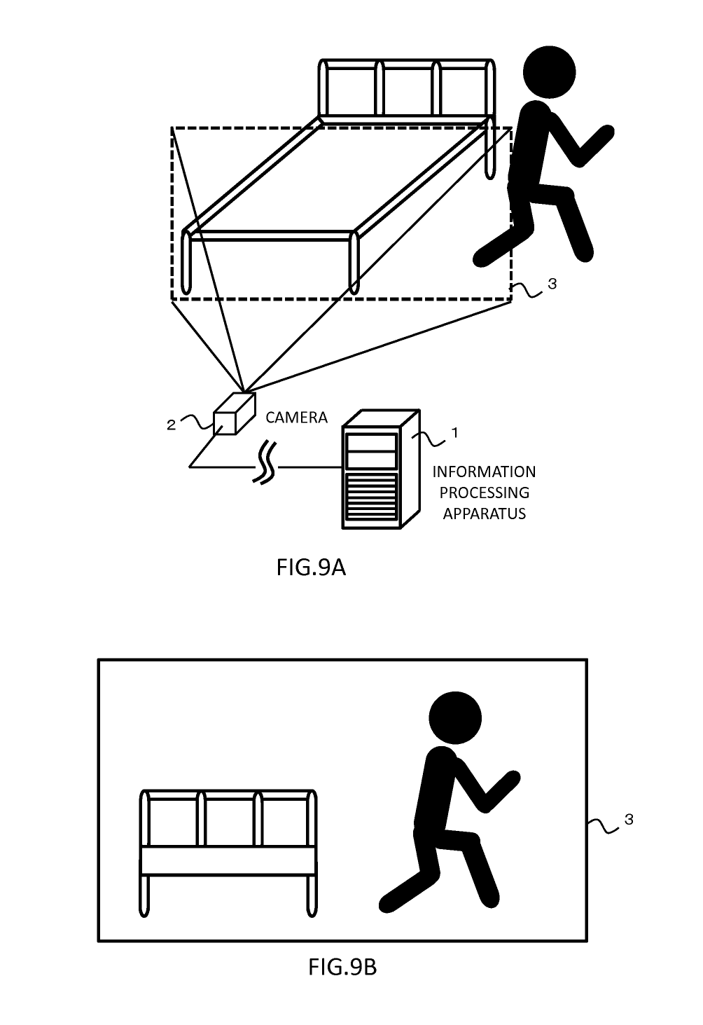

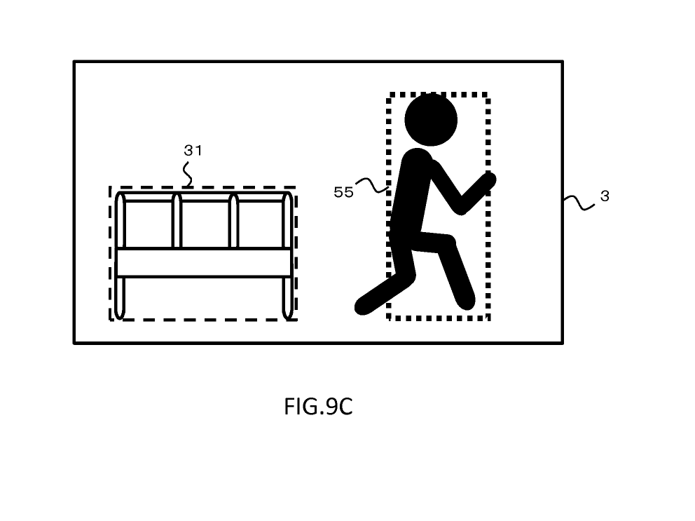

FIGS. 9A-9C are views each related to a motion in the leaving-bed state. FIG. 9A illustrates a situation where the watching target person leaves the bed. FIG. 9B depicts one situation in the moving image 3 captured by the camera 2 when the watching target person leaves the bed. FIG. 9C illustrates a positional relationship between the moving object to be detected and the target object (bed) in the moving images 3 acquired when the watching target person leaves the bed. Herein, for the same reason as the situations in the sitting-on-bed-edge state, in the over-bed-fence state and in the come-down state, FIGS. 9A-9C each illustrate a situation in which the watching target person leaves the bed from the bed on the right side as viewed from the camera 2.

When the watching target person leaves the bed as illustrated in FIG. 9A, the control unit 11 of the information processing apparatus 1 can acquire in step S101 the moving images 3 covering one situation as illustrated in FIG. 9B. At this time, the watching target person leaves the bed toward the right side as viewed from the camera 2, and hence it is assumed that the motion occurs in the vicinity of the position distanced rightward from the bed in the moving images 3 acquired in step S101. To be specific, a moving-object area 55 is assumed to be detected in step S102 in the vicinity of the position illustrated in FIG. 9C, in other words, in the position distanced rightward from the target object area 31.

This being the case, in step S103, the control unit 11, when the moving-object area 55 is detected in the positional relationship with the target object area 31 as illustrated in FIG. 9C, in other words, when the moving-object area 55 is detected in the position distanced rightward from the target object area 31, presumes that the watching target person leaves the bed.

(f) Others

The states (a)-(e) have demonstrated the situations in which the control unit 11 presumes the respective behaviors of the watching target person corresponding to the positional relationships between the moving-object area 51-55 detected in step S102 and the target object area 31. The presumption target behavior in the behaviors of the watching target person may be properly selected corresponding to the embodiment. In the present embodiment, the control unit 11 presumes at least any one of the behaviors of the watching target person such as (a) the get-up state, (b) the sitting-on-bed-edge state, (c) the over-bed-fence state, (d) the come-down state and (e) the leaving-bed state. The user (e.g., the watcher) may determine the presumption target behavior by selecting the target behavior from the get-up state, the sitting-on-bed-edge state, the over-bed-fence state, the come-down state and the leaving-bed state.

Herein, the states (a)-(e) demonstrate conditions for presuming the respective behaviors in the case of utilizing the camera 2 disposed in front of the bed in the longitudinal direction to project the bed on the left side within the moving images 3 to be acquired. The positional relationship between the moving-object area and the target object area, which becomes the condition for presuming the behavior of the watching target person, can be determined based on where the camera 2 and the target object (bed) are disposed and what behavior is presumed. The information processing apparatus 1 may retain, on the storage unit 12, the information on the positional relationship between the moving-object area and the target object area, which becomes the condition for presuming that the watching target person performs the target behavior on the basis of where the camera 2 and the target object are disposed and what behavior is presumed. Then, the information processing apparatus 1 accepts, from the user, selections about where the camera 2 and the target object are disposed and what behavior is presumed, and may set the condition for presuming that the watching target person performs the target behavior. With this contrivance, the user can customize the behaviors of the watching target person, which are presumed by the information processing apparatus 1.

Further, the information processing apparatus 1 may accept, if the watching target person performs the presumption target behavior that the user desires to add, designation of an area within the moving images 3 in which the moving-object area will be detected from the user (e.g., the watcher). This scheme enables the information processing apparatus 1 to add the condition for presuming that the watching target person performs the target behavior and also enables an addition of the behavior set as the presumption target behavior of the watching target person.

Note that in the respective behaviors in the states (a)-(e), it is presumed that the dynamic bodies will appear in a fixed or larger quantity of areas in predetermined positions. Therefore, the control unit 11 may presume the behavior of the watching target person with respect to the target object (bed) in a way that corresponds to a size of the detected moving-object area. For example, the control unit 11 may, before making the determination as to the presumption of the behavior described above, determine whether the size of the detected moving-object area exceeds the fixed quantity or not. Then, the control unit 11, if the size of the detected moving-object area is equal to or smaller than the fixed quantity, may ignore the detected moving-object area without presuming the behavior of the watching target person on the basis of the detected moving-object area. Whereas if the size of the detected moving-object area exceeds the fixed quantity, the control unit 11 may presume the behavior of the watching target person on the basis of the detected moving-object area.

Moreover, if the moving-object area is detected other than in the areas given about the behaviors in the states (a)-(e), the control unit 11 may presume that the most recently presumed behavior is kept conducting because of presuming that the watching target person does not move when the detected moving-object area does not exceed the predetermined quantity of size. Whereas when the detected moving-object area exceeds the predetermined quantity of size, the control unit 11 may presume that the watching target person is in a behavior state other than the states (a)-(e) because of presuming that the watching target person performs a behavior other than in the states (a)-(e).

In step S104, the control unit 11 determines whether or not the behavior presumed in step S103 is the behaving indicating the symptom that the watching target person will encounter with the impending danger. If the behavior presumed in step S103 is the behaving indicating the symptom that the watching target person will encounter with the impending danger, the control unit 11 advances the processing to step S105. Whereas if the behavior presumed in step S103 is not the behaving indicating the symptom that the watching target person will encounter with the impending danger, the control unit 11 finishes the processes related to the present operational example.

The behavior set as the behavior indicating the symptom that the watching target person will encounter with the impending danger, may be properly selected corresponding to the embodiment. For instance, an assumption is that the sitting-on-bed-edge state is set as the behavior indicating the symptom that the watching target person will encounter with the impending danger, i.e., as the behavior having a possibility that the watching target person will come down or fall down. In this case, the control unit 11, when presuming in step S103 that the watching target person is in the sitting-on-bed-edge state, determines that the behavior presumed in step S103 is the behavior indicating the symptom that the watching target person will encounter with the impending danger.

Incidentally, when determining whether or not there exists the symptom that the watching target person will encounter with the impending danger, it is better to take account of transitions of the behaviors of the watching target person as the case may be. For example, it can be presumed that the watching target person has a higher possibility of coming down or falling down in a transition to the sitting-on-bed-edge state from the get-up state than a transition to the sitting-on-bed-edge state from the leaving-bed state. Such being the case, in step S104, the control unit 11 may determine, based on the transitions of the behavior of the watching target person, whether the behavior presumed in step S103 is the behavior indicating the symptom that the watching target person will encounter with the impending danger or not.

For instance, it is assumed that the control unit 11, when periodically presuming the behavior of the watching target person, presumes that the watching target person becomes the sitting-on-bed-edge state after presuming that the watching target person has got up. At this time, the control unit 11 may presume in step S104 that the behavior presumed in step S103 is the behavior indicating the symptom that the watching target person will encounter with the impending danger.

In step S105, the control unit 11 functions as the notifying unit 24 and issues the notification for informing of the symptom that the watching target person will encounter with the impending danger to the watcher who watches the watching target person.

The control unit 11 issues the notification by use a proper method. For example, the control unit 11 may display, byway of the notification, a window for informing the watcher of the symptom that the watching target person will encounter with the impending danger on a display connected to the information processing apparatus 1. Further, e.g., the control unit 11 may give the notification via an e-mail to a user terminal of the watcher. In this case, for instance, an e-mail address of the user terminal defined as a notification destination is registered in the storage unit 12 on ahead, and the control unit 11 gives the watcher the notification for informing of the symptom that the watching target person will encounter with the impending danger by making use of the e-mail address registered beforehand.

Further, the notification for informing of the symptom that the watching target person will encounter with the impending danger may be given in cooperation with the equipment installed in the facility such as the nurse call system. For example, the control unit 11 controls the nurse call system connected via the external I/F 15, and may call up via the nurse call system as the notification for informing of the symptom that the watching target person will encounter with the impending danger. The facility equipment connected to the information processing apparatus 1 may be properly selected corresponding to the embodiment.

Note that the information processing apparatus 1, in the case of periodically presuming the behavior of the watching target person, periodically repeats the processes given in the operational example described above. An interval of periodically repeating the processes may be properly selected. Furthermore, the information processing apparatus 1 may also execute the processes given in the operational example described above in response to a request of the user (watcher).

The information processing apparatus 1 according to the present embodiment detects the moving-object area from within the moving images 3 captured as the image of the watching target person and the image of the target object serving as the reference for the behavior of the watching target person. Then, the behavior of the watching target person with respect to the target object is presumed corresponding to the positional relationship between the detected moving object and the target object area. Therefore, the behavior of the watching target person can be presumed by the simple method without introducing the high-level image processing technology such as the image recognition.

Moreover, the information processing apparatus 1 according to the present embodiment does not analyze details of the content of the moving object within the moving images 3 captured by the camera 2 but presume the behavior of the watching target person on the basis of the positional relation between the target object area and the moving-object area. Therefore, the user can check whether the information processing apparatus 1 is correctly set in the individual environments of the watching target person or not by checking whether the area (condition) in which the moving-object area for the target behavior will be detected is correctly set or not. Consequently, the information processing apparatus 1 can be built up, operated and manipulated comparatively simply.

### §4 Modified Example

The in-depth description of the embodiment of the present invention has been made so far but is no more than the exemplification of the present invention in every point. The present invention can be, as a matter of course, improved and modified in the variety of forms without deviating from the scope of the present invention.

(Detection Area)

The control unit 11 functions as the moving object detecting unit 22, and may detect the moving-object area in a detection area set as an area for presuming the behavior of the watching target person within the acquired moving images 3. Specifically, the moving object detecting unit 22 may confine in step S102 the area for detecting the moving-object area in step S102 to the detection area. With this contrivance, the information processing apparatus 1 can diminish the range in which the moving object is detected and is therefore enabled to execute the process related to the detection of the moving object at a high speed.

Further, the control unit 11 functions as the moving object detecting unit 22 and may detect the moving-object area in the detection area determined based on the types of the behaviors of the watching target person, which are to be presumed. Namely, the detection area set as the area for detecting the moving object may be determined based on the types of the behaviors of the watching target person that are to be presumed.

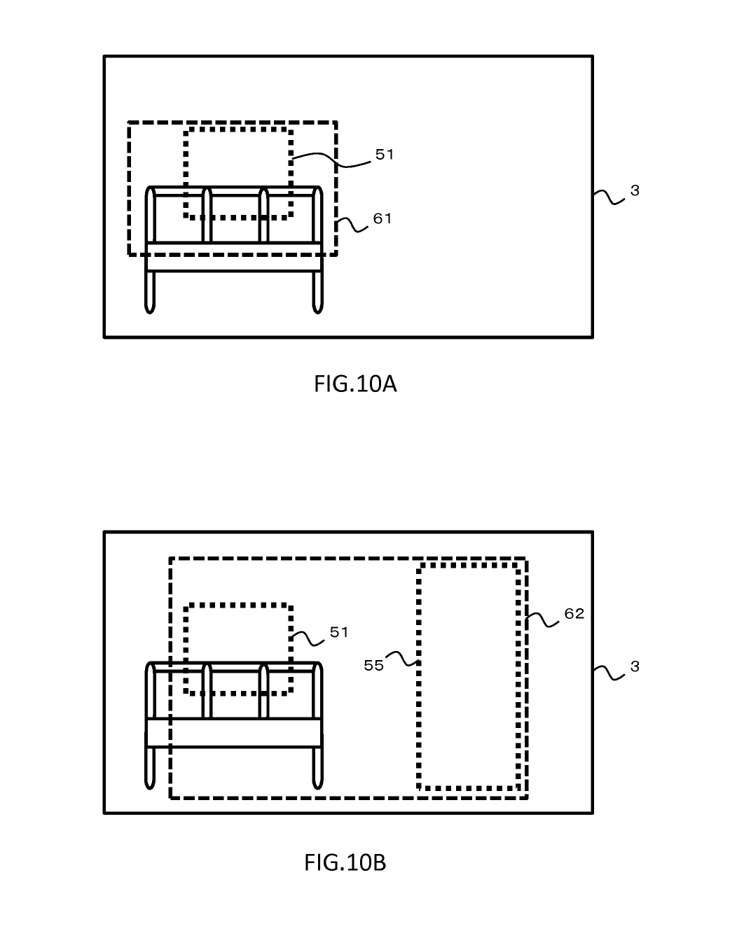

FIGS. 10A and 10B illustrate how the detection area is set. A detection area 61 depicted in FIG. 10A is determined based on presuming that the watching target person gets up from the bed. Further, a detection area 62 illustrated in FIG. 10B is determined based on presuming that the watching target person gets up from the bed and then leaves the bed.

Referring to FIGS. 10A and 10B, in a situation of FIG. 10A with no presumption of the leaving-bed state, the information processing apparatus 1 may not detect the moving object in the vicinity of the moving-object area 55 in which the moving object is assumed to occur on the occasion of the leaving-bed state. Furthermore, the information processing apparatus 1, in the case of not presuming the behaviors exclusive of the get-up state, may not detect the moving-object area from the area excluding the vicinity of the moving-object area 51.

This being the case, the information processing apparatus 1 may set the detection area on the basis of the types of the presumption target behaviors of the watching target person. This detection area being thus set, the information processing apparatus 1 according to the present embodiment can ignore the moving object occurring in the area unrelated to the presumption target behavior and therefore can enhance the accuracy of presuming the behavior.

According to one aspect, the present embodiment aims at providing the technology of presuming the behavior of the watching target person by the simple method. Then, as discussed above, according to the present embodiment, it is feasible to provide the technology of presuming the behavior of the watching target person by the simple method.

1. An information processing apparatus comprising:
an image acquiring unit to acquire moving images captured as an image of a watching target person whose behavior is watched and an image of a target object serving as a reference for the behavior of the watching target person;
a moving object detecting unit to detect a moving-object area where a motion occurs from within the acquired moving images; and
a behavior presuming unit to presume a behavior of the watching target person with respect to the target object in accordance with a positional relationship between a target object area set within the moving images as an area where the target object exists and the detected moving-object area.

2. The information processing apparatus according to claim 1, wherein the behavior presuming unit presumes the behavior of the watching target person with respect to the target object further in accordance with a size of the detected moving-object area.

3. The information processing apparatus according to claim 1, wherein the moving object detecting unit detects the moving-object area from within a detection area set as area for presuming the behavior of the watching target person in the acquired moving images.

4. The information processing apparatus according to claim 3, wherein the moving object detecting unit detects the moving-object area from within the detection area determined based on types of the behaviors of the watching target person that are to be presumed.

5. The information processing apparatus according to claim 1, wherein the image acquiring unit acquires the moving image captured as an image of a bed defined as the target object, and
the behavior presuming unit presumes at least any one of the behaviors of the watching target person such as a get-up state on the bed, a sitting-on-bed-edge state, an over-bed-fence state, a come-down state from the bed and a leaving-bed state.

6. The information processing apparatus according to claim 1, further comprising a notifying unit to notify, when the presumed behavior of the watching target person is a behavior indicating the symptom that the watching target person will encounter with an impending danger, a watcher to watch the watching target person of this symptom.

7. An information processing method by which a computer executes:
acquiring moving images captured as an image of a watching target person whose behavior is watched and an image of a target object serving as a reference for the behavior of the watching target person;
detecting a moving-object area where a motion occurs from within the acquired moving images; and
presuming a behavior of the watching target person with respect to the target object in accordance with a positional relationship between a target object area set within the moving images as an area where the target object exists and the detected moving-object area.

8. A non-transitory recording medium recording a program to make a computer execute:
acquiring moving images captured as an image of a watching target person whose behavior is watched and an image of a target object serving as a reference for the behavior of the watching target person;
detecting a moving-object area where a motion occurs from within the acquired moving images; and
presuming a behavior of the watching target person with respect to the target object in accordance with a positional relationship between a target object area set within the moving images as an area where the target object exists and the detected moving-object area.
